(19) United States
(12) Patent Application Publication
(10) Pub. No.: US 2008/0198292 A1
(43) Pub. Date: Aug. 21, 2008

(54) Lighting Device

(75) Inventors: Johan Marra, Eindhoven (NL); Dirk Kornelis Gerhardus De Boer, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/915,020

(22) PCT Filed: May 12, 2006
(86) PCT No.: PCT/IB06/51491

§ 371 Date: Nov. 20, 2007

(30) Foreign Application Priority Data
May 27, 2005 (EP) 05104566.4

(51) Int. Cl. G02F 1/13357; F21V 8/00

(52) U.S. Cl. 349/61; 362/276

(57) ABSTRACT

The present invention relates to a lighting device wherein an in-coupled light flow is at least partly constrained within a light-guide plate (4) by means of total internal reflection. The device includes means for achieving a selective local light output from the output surface (6) of the light-guide plate, such that the intensity of the emitted light flow from the light guide can be locally controlled over its output surface area. This is achieved by a number of closed cells adjoining the output surface. Each cell contains a liquid element (11), the form of which may be manipulated by electrowetting, such that the liquid can be brought to a greater or lesser extent into optical contact or out of optical contact with a local area of the output surface (6), thereby varying the intensity of the locally out-coupled light flow therethrough. The cell may be built up by the light-guide plate (4), a support plate (8) and lateral wall parts (9,10). The support plate (8) may consist of a hydrophobized glass plate, which is positioned parallel to the light-guide plate (4).

### FIELD OF THE INVENTION

The present invention relates to a lighting device comprising a light-guide plate, said light-guide plate having first and second main surfaces and being arranged to receive light from at least one light source and to at least partly constrain the light therein by total internal reflection, and at least one local out-coupling device being arranged to selectively extract light from a local area of said second main surface by reducing the index of refraction drop at said local area.

### BACKGROUND OF THE INVENTION

Such a lighting device comprising a moveable light-scattering foil is disclosed in e.g. WO A1 2004/027468. The moveable foil can be made by applying a voltage-induced electrostatic force, either to locally contact the second main surface in order to locally extract light therefrom, or it can be made to locally remain out of contact with the second main surface so that no light is locally extracted. The arrangement with the moveable foil allows the lighting device to function in an “intelligent” manner, such that, when the lighting device is used e.g. as a backlighting unit in an LCD-TV, relatively more light can be produced in areas where much light is needed (to locally produce bright high-lighted parts in an image), while relatively less light can simultaneously be produced in other areas where less, if any, light is needed (to locally produce dark parts in an image). Thus, less energy may be consumed and the image contrast is improved.

However, such an arrangement may be quite complex, and the light output resolution is low as compared with the resolution of e.g. an LCD panel. In addition, it has been found that the repeated motion of a moveable foil to and from the second main surface of a light-guide plate gradually induces mechanical wear of the foil and/or the second main surface, which can easily lead to a marked deterioration of the intended function of the lighting device.

### OBJECT AND SUMMARY OF THE INVENTION

It is therefore an object of the present invention to provide a lighting device of the type described in the opening paragraph, which is less complex, less prone to mechanical wear, and hence more competitive in terms of cost and reliability.

This object is achieved with a lighting device as defined in claim 1.

More specifically, the local out-coupling device comprises: a cell adjoining the second main surface and containing first and second immiscible media, the first medium being a liquid and the second medium having a lower index of refraction than the first medium; and an electrode arrangement, which is arranged to selectively alter the shape of the interface between the first and second media such that, in a first state, the second medium substantially covers the second main surface in the local area so as to prohibit local optical contact between the first medium and the second main surface, while in a second state, the first medium is in optical contact with the second main surface at the local area and enables light out-coupling therethrough.

Such a device is less complex and can provide a more reliable out-coupling effect. Moreover, since the interface between the first and second media can be varied continuously, the percentage of the local area of the second main surface of the light-guide plate, or light guide for short, which is optically contacted by the liquid can also be varied. Therefore, the light output in the local area can be finely tuned. An out-coupling device of this type may also be miniaturized to a great extent.

It is generally preferred to ensure that the second main surface of the light-guide plate, at least at the local area where the second main surface can come into optical contact with the first medium, is covered with an ultrahydrophobic coating, such that said optical contact is not accompanied by an occurrence of a substantial adhesive interaction between the second main surface and the first medium. This avoids adhesive “sticking” of the first medium to the second main surface, so that an easy and reliable withdrawal of the first medium from optical contact with the second main surface can be ensured in response to an alteration of the shape of the interface between said first and second media.

The cell may be defined by a transparent support plate, the light-guide plate and lateral wall parts interconnecting the support plate and the light-guide plate. The transparent support plate may comprise first and second main surfaces, the first main surface facing the cell and the second main surface facing away from the cell, comprising an optional out-coupling structure. This optional out-coupling structure serves to provide the emitted light from said lighting device with a confined angular light distribution. This may be useful when the lighting device is used e.g. in a back-lighting arrangement or in a general lighting arrangement.

The lighting device may comprise a light source, which is arranged to feed light through an edge of the light-guide plate, the edge interconnecting the first and second main surfaces of the light guide. This allows the realization of a very thin lighting device structure.

Alternatively, the lighting device may comprise at least one light source, which is arranged to feed light through the first main surface of the light-guide plate, the first main surface comprising an in-coupling structure to couple light into the light-guide plate in such a way that the in-coupled light propagates through the light-guide plate within a defined and limited angular range that supports the occurrence of total internal reflection within the light guide. This allows the realization of a greater amount of light input into the light-guide plate, which is important when large-area light-guide plates are involved and/or when the locally out-coupled light should have a high intensity. The device may then comprise a reflector, the reflector and the light-guide plate enclosing the light source. This allows light recycling within the space between the reflector and the light-guide plate of the lighting device, serving to increase both the intensity and the lateral homogeneity of the in-coupled light into the light guide. Light recycling also helps to enhance the intensity of the out-coupled light from the lighting device.

The device may comprise a matrix of individually controllable out-coupling devices, and may be arranged as a backlighting unit in a display device such as a liquid crystal display. Alternatively, the device may be incorporated in a general (room-)lighting arrangement.

The liquid contained within the respective out-coupling devices may be colored so as to realize a coloring of the out-coupled light from the lighting device. Different out-coupling devices within the lighting device may either contain similarly colored liquids or differently colored liquids.

These and other aspects of the invention are apparent from and will be elucidated with reference to the embodiments described hereinafter.

### BRIEF DESCRIPTION OF THE DRAWINGS

FIG. 1 illustrates schematically a conventional back-lit LCD panel.

FIG. 2 illustrates an LCD panel having a backlight device with locally variable output.

FIG. 3a illustrates schematically a lighting device in accordance with an embodiment of the present invention.

FIG. 3b is a perspective view of a cell layout in a first embodiment.

FIG. 3c is a perspective view of a cell layout in a second embodiment.

FIG. 4 illustrates in a cross-section out-coupling arrangements in three different states.

FIG. 5 illustrates another embodiment of the present invention.

### DESCRIPTION OF EMBODIMENTS

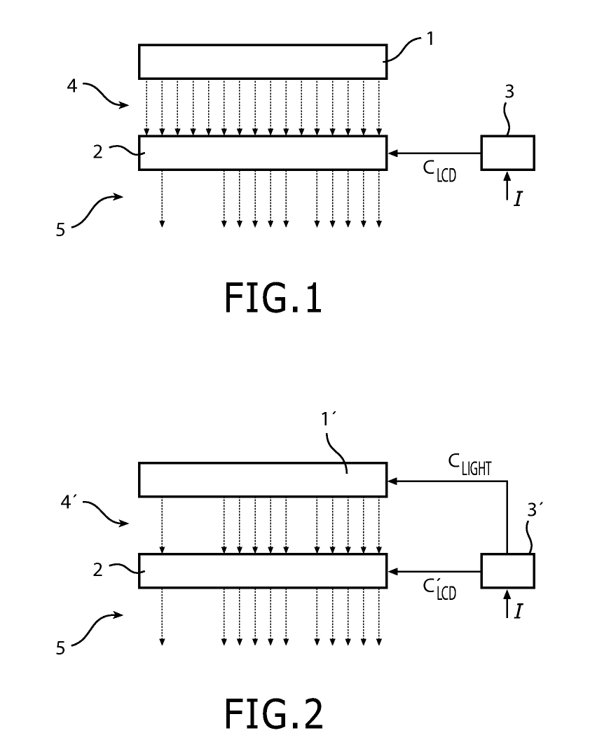

FIG. 1 illustrates schematically in a cross-section a conventional back-lit LCD (Liquid Crystal Display) panel. A backlighting device 1 outputs light 4 from its front surface laterally and as evenly distributed as possible. An LCD layer 2 receives a control signal CLCD from a control unit 3, which generates the control signal CLCD in accordance with a received image signal I. The light outputted from the backlighting device is modulated by means of the transmissive LCD layer 2 to produce an image 5, corresponding to the image signal. The LCD layer 2 comprises various sub-layers such as polarizers, etc., as is well known in the art.

FIG. 2 illustrates an LCD panel (e.g. an LCD-TV) having a backlighting device 1′ with locally variable light output 4′. This means that the backlighting device 1′ will produce more light in some areas of its output surface and less in others in an intelligent manner, such that areas of the LCD panel 2 that are supposed to display dark parts of an image receive relatively less light from the backlighting device than areas that are supposed to display bright parts. The backlighting device 1′ may thus receive a control signal CLIGHT from the control unit 3′. This control signal should specify the amount of light to be outputted from different local areas of the backlighting device 1′. The LCD control signal C′LCD should be adapted to the intelligent backlight, because a conventional LCD control signal assumes a uniform backlighting level.

The intelligent backlighting device has two main advantages. First, less power may be consumed, because less light is wasted on dark areas, where light is absorbed by the LCD layer 2. Secondly, image characteristics may be improved. For instance, in a conventional arrangement, a black pixel will not be “true black”, because some leakage of light through the pixel may still occur. If, however, the light flow to such pixels from the backlighting device is reduced, this property of the image will be improved.

The present invention aims at providing a lighting device that may function as such a backlighting device 1′. It should be noted, however, that such a device may be used in contexts other than those described above. For example, the lighting device may be used in connection with display technologies other than LCD. The lighting device may in itself also function as a display. It is also possible to use the lighting device in general (e.g. room-) lighting applications.

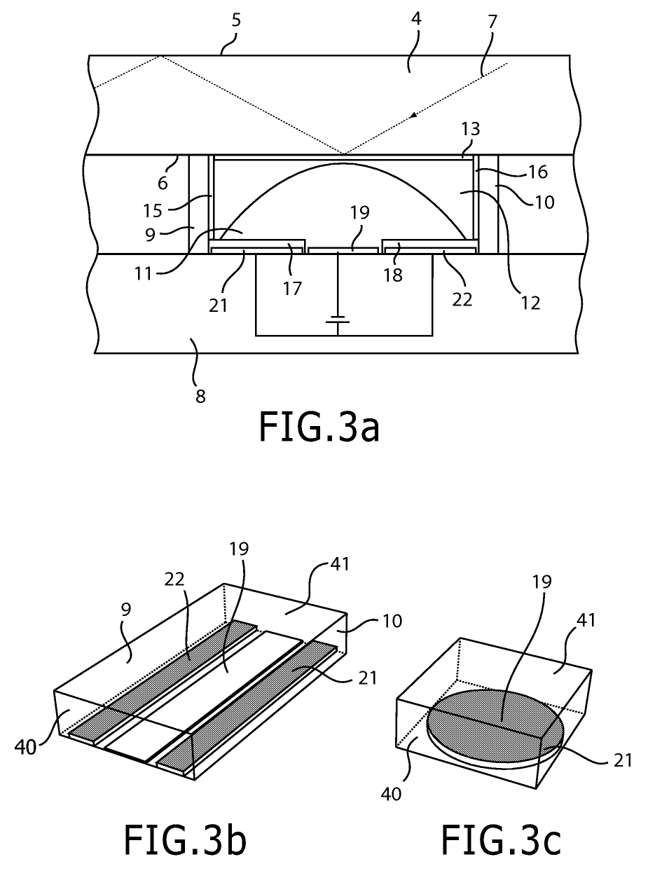

FIG. 3a illustrates schematically in a cross-section a lighting device in accordance with an embodiment of the present invention. The lighting device comprises a light-guide plate 4, or light guide for short, having first and second main surfaces 5 and 6, respectively.

The light-guide plate 4 receives light from a light source (not shown), in a manner to be discussed hereinafter, in such a way that the received light propagates through the light guide within an angular range of directions of propagation substantially supporting the occurrence of total internal reflection of the light rays within the light-guide plate 4. The result is that most light rays will be reflected at the first and second main surfaces 5, 6 of the light-guide plate 4, due to a significant refractive index drop at these surfaces. The inputted light 7 is therefore constrained to a substantial extent within the light-guide plate 4 by total internal reflection.

The lighting device further comprises at least one local out-coupling device (or a plurality in a typical application). This device is capable of extracting light from the second main surface 6. Each local out-coupling device may correspond to a set of pixels in a display, thus transmitting controllable amounts of light to these pixels. The out-coupling devices are preferably arranged in an array, in which each out-coupling device is addressable similarly to a pixel in a display.

With reference to FIG. 3a, the function of the local out-coupling device may be based on the so-termed electrowetting effect which is known per se (see e.g. WO 03/071335, A1). In general, according to the electrowetting effect, a finite amount of a conductive liquid (e.g. a water droplet or an elongated water line/ridge) which, at least at its edges, is in contact with a hydrophobic surface of a support plate, can be made to change the degree by which it wets this hydrophobic surface by applying different voltages to a first electrode 19, which is in direct galvanic contact with the conductive liquid, and to second electrodes 21, 22, which are buried just underneath the hydrophobic surface of said support plate, respectively, the buried electrodes 21,22 being insulated from the liquid by means of separating insulating hydrophobic coatings 17,18, respectively. These buried electrodes 21,22 are sufficiently wide to cover the 3-phase contact line between the liquid 11, the medium 12 adjacent to the liquid (usually air), and the hydrophobic surfaces of the coatings 17, 18 on the support plate 8, at all intended wetting degrees of the hydrophobic coatings 17, 18. Changes in the voltages applied to the electrode 19 and the electrodes 21,22, respectively, also alter the shape of the interface between the liquid 11 and the medium 12 adjacent to the liquid (usually a gas such as air). In FIG. 3a, the voltage-induced alteration of the shape of the interface between the media 11, 12 can be used to bring the liquid medium 11 either out of optical contact or into optical contact with the second main surface 6 of the light guide 4.

The out-coupling device preferably comprises a closed cell adjoining the second main surface 6. The cell may be built up by the light-guide plate 4, a support plate 8, and lateral wall parts 9, 10. The support plate 8 may consist of a hydrophobized glass plate, which is positioned parallel to the light-guide plate 4. The lateral wall parts 9, 10 may constitute spacers interconnecting the light-guide plate and the support plate. The surfaces of the lateral wall parts 9, 10 that contact the second main surface 6 are preferably reflective metallic surfaces in order to avoid any interference between the presence of the lateral wall parts and the propagation of light through the light-guide plate 4.

The cell is filled with a first and a second medium 11 and 12, respectively. In this embodiment, the first medium 11 is a conductive liquid, such as an aqueous electrolyte solution. The second medium 12 may be a gas, such as air, having a considerably lower index of refraction than the first medium 11 and the light-guide plate 4. Different cells may contain liquids that are colored in different ways.

The surfaces of the support plate that are associated with out-coupling devices are to be covered with a thin smooth hydrophobic coating 17,18, comprising, for example, TEFLON® AF 1600 material, except at the position of the electrode 19, used to impart a voltage to the first medium 11. The surface of the electrode 19 is preferably hydrophilic in nature, i.e. it becomes well-wetted by a conductive first medium liquid such as water. In addition, also the surfaces of the lateral wall parts 9, 10 facing the first medium 11 are preferably covered with thin hydrophobic coatings 15, 16 serving to counteract a spontaneous wetting of the lateral wall parts by the first medium 11. Finally, it is most preferable that the second main surface 6 of the light-guide plate 4 at the position of an out-coupling element is covered with an ultrahydrophobic coating 13. The coating 13 is preferably a nano-roughened fractal-like assembly of hydrophobic nanoparticles with an overall layer thickness of less than about 100 nm. The latter limited layer thickness ensures that a tunneling of light from the light guide 4 into the first medium 11 will occur through evanescent coupling when the first medium 11 is brought into physical contact with the coating 13.

As such, a physical contact between the first medium 11 and the coating 13 also leads to an effective optical contact between the first liquid medium 11 and the second main surface 6 of the light guide 4, and thus to light out-coupling/light extraction. A fractal-like assembly of hydrophobic nanoparticles on the surface 6 can be realized through spincoating of a suitable nanoparticle dispersion in a liquid across the surface 6 of the light guide 4, followed by drying, or through an electrostatically augmented aerosol deposition of charged aerosolized hydrophobic nanoparticles from air. The ultrahydrophobicity of the coating 13 on the second main surface 6 serves to avoid the existence of any substantial adhesive interaction between the first medium 11 and the second main surface 6 when these are brought into optical contact with each other.

The electrodes 19, 21, 22 should preferably be transparent, and may consist of ITO (Indium Tin Oxide) layers.

Due to surface tension effects, the liquid 11 will be in a relaxed state at a zero potential difference between the electrode 19 and the electrodes 21, 22, respectively, thereby entirely covering the free hydrophilic surface at and around electrode 19 but only a very limited part of the adjacent surface of the hydrophobic coatings 17 and 18 that cover the electrodes 21 and 22. By applying a voltage difference V between the electrodes 21, 22 and the electrode 19, which is in galvanic contact with the liquid 11, a potential difference V is set up between the liquid 11 and the electrodes 21, 22 across the hydrophobic coatings 17, 18, causing the liquid 11 to cover a greater part of the surface of the coatings 17, 18 than in the relaxed state (no voltage difference applied). This is accompanied by a change in the shape of the interface between the liquid 11 and the quantity of gas 12 in the cell. In FIG. 3a, a substantial voltage difference is applied between the electrodes 21, 22 and the liquid 11, and the interface between the liquid 11 and the gas 12 has acquired such a shape that there is no physical contact between the liquid 11 and the ultrahydrophobic coating 13 on the second main surface 6 of the light guide 4. Here, substantially the entire width of the surface of the support plate in between the lateral wall parts 9,10 has become wetted by the liquid medium 11.

FIG. 3b is a perspective view of a cell layout in a first embodiment. The lateral wall parts 9, 10 are covered by a hydrophobic material, but the front and back wall parts 40, 41 (as seen in the drawing) are moderately hydrophilic, such that the liquid (not shown) will at least partially wet these walls. The hydrophilic electrode 19 on the support plate covers a trace between the front and back wall parts 40, 41. The liquid will therefore have the shape of a cylindrical cap, similar to that of a cylindrical convex lens.

FIG. 3c is a perspective view of a cell layout in a second embodiment. Both the lateral wall parts and the front and back wall parts 40, 41 have hydrophobic coatings. The hydrophilic surface of the electrode 19 on the support plate is confined to the center of the cell, and the electrode 21 (only one buried electrode needed in this case) surrounds this area. In this alternative, the liquid will approximately have the shape of a spherical cap.

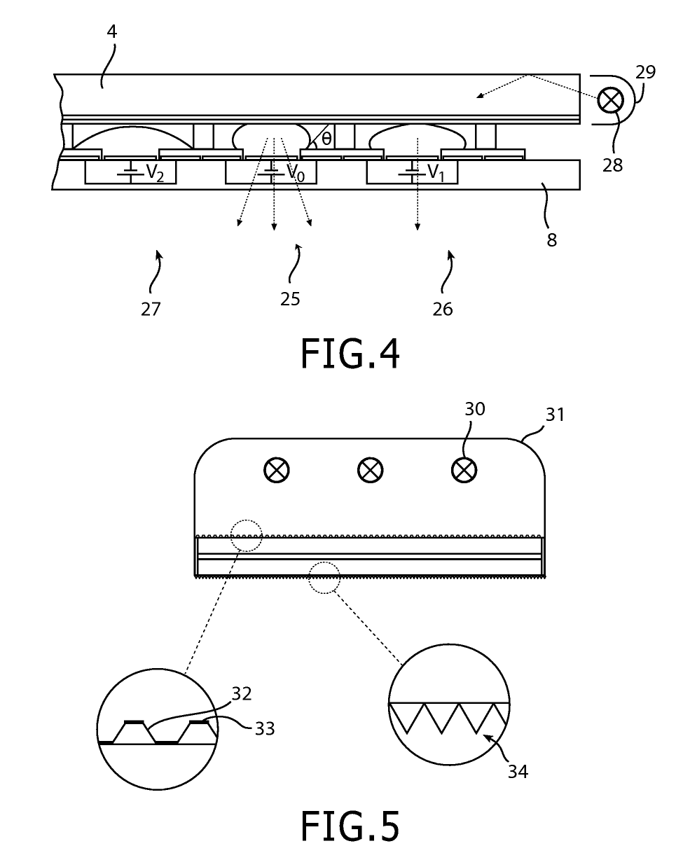

FIG. 4 illustrates in a cross-section out-coupling arrangements in three different states. A cell in a first state is illustrated at 25. In this cell 25, a zero voltage difference, V₀=0 V, is applied between the liquid 11 in the cell and the electrodes 21, 22. In this state, the liquid wets the structured hydrophobic coating on the support plate 8 to only a very limited extent, and the liquid quantity thus has a maximal curvature, i.e. the contact angle θ between the liquid and the support plate, as measured outside the liquid, is relatively small. The liquid therefore reaches out from the support plate and covers a maximum percentage of the local area of the second main surface 6 of the light-guide plate 4. In the covered local area, the refractive index drop between the light-guide plate and the adjacent liquid will be small, zero or even negative, thus frustrating in this local area, to a greater or lesser extent, the total internal reflections of the propagating light rays within the light guide. This remains true if a fractal-like ultrahydrophobic coating is present on the second main surface of the light guide 4, provided that this coating has a thickness of less than about 100 nm. The result is a maximal light output from the light-guide plate in this area, the extracted light first entering the liquid medium 11 and subsequently the support plate 8 from where it is emitted into air away from the lighting device.

In a second cell, indicated at 26, a non-zero voltage difference V₁ is applied between the liquid 11 and the electrodes 21, 22. This induces an increased degree of wetting of the hydrophobic coating that covers the electrodes 21, 22, thereby reducing the curvature of the liquid in the cell, which leads to a reduction of the optical contact area between the liquid and the light guide 4. Thus, the liquid 11 touches a smaller percentage of the local light-guide plate 4 area, and the out-coupled light flow from the light-guide plate into the liquid is consequently reduced, as illustrated in the drawing.

In cell 27, a still greater voltage difference [symbol] Vis applied between the liquid and the electrodes 21, 22, which causes the liquid to wet a further increased part of the surface of the hydrophobic coating covering the electrodes 21, 22. The liquid curvature is thereby reduced even further to such a degree that the liquid no longer touches the light-guide plate and is out of optical contact therewith. Instead, substantially the entire local area is covered by the gas medium, such that the out-coupled light flow from the local area into the liquid medium is reduced to essentially zero due to the large refractive index drop at that local area. Provided that a fractal-like nano-roughened ultrahydrophobic coating is present on the second main surface of the light guide 4, no substantial adhesive sticking of the liquid to the light-guide plate will occur and the liquid can easily be brought out of optical contact with the light-guide plate 4 in response to an increase of the applied voltage difference V between the liquid and the electrodes 21, 22.

The embodiment illustrated in FIG. 4 is edge-lit, which means that a light source 28, e.g. a fluorescent lamp, is arranged to input light into an edge of the light-guide plate 4, where the edge interconnects the first and second main surfaces of the light-guide plate. A reflector 29 is preferably arranged behind the light source 28 as viewed from the light-guide edge, in order to concentrate the light flow towards said edge.

FIG. 5 illustrates another embodiment of the present invention. In this embodiment, a number of light sources 30 are facing the first main surface of the light-guide plate 4. A reflector 31 is placed behind the light sources as viewed from the light-guide plate 4. The first main surface of the light-guide plate is covered by an in-coupling structure. The in-coupling structure is arranged and structured in such a way as to feature reflective surfaces 33 and optically smooth transmissive surfaces 32. The transmissive surfaces 32 function as in-coupling surfaces that allow light rays to enter the light guide 4. The in-coupling surfaces 32 are oriented with respect to the plane of the first main surface of the light guide 4 at such an angle (usually 90° or close to 90°) that in-coupled light rays enter the light guide within a limited angular range that allows their propagation through the light guide to occur by means of total internal reflection, similar to what is described in WO 2004/027467, A1. As such, the in-coupled light becomes at least partly constrained within the light guide. Mirrors are placed at the edges of the light-guide plate. The in-coupled light can leave the light guide either through the in-coupling surfaces 32 themselves, after which they are recycled within the space between the light guide 4 and the reflector 31, or locally via the liquid medium 11 when the liquid medium has locally been brought into optical contact with the light guide 4.

It is also possible to provide the support plate 8 with an out-coupling structure such as the triangular structure 34 shown in FIG. 5. This is done on the side of the support plate 8 facing away from the out-coupling devices. Such a structure is used to at least partially collimate the light and/or at least partially confine the light that is ultimately emitted by the lighting device to within a limited angular range. If no out-coupling structure is provided at the second main surface of the support plate 8, the light emitted therefrom will have a relatively more diffuse character.

In summary, the invention relates to a lighting device wherein an in-coupled light flow is at least partly constrained within a light-guide plate by means of total internal reflection. The device includes means for achieving a selective local light output from the output surface of the light-guide plate, such that the intensity of the emitted light flow from the light guide can be locally controlled over its output surface area. This is achieved by a number of closed cells adjoining the output surface. Each cell contains a liquid element, the form of which may be manipulated by electrowetting, such that the liquid element can be brought to a greater or lesser extent into optical contact or out of optical contact with a local area of the output surface, thereby varying the intensity of the locally out-coupled light flow therethrough. Such a lighting device may be used as a backlighting arrangement used in e.g. an LCD-TV, or for general lighting purposes, e.g. as light tiles featuring a (colored) light output. The intensity and color of the (colored) light output can be locally adjusted across the emitting surface area of the light tile.

The invention is not limited to the embodiment described hereinbefore. It can be altered in different ways within the scope of the appended claims.

1. A lighting device comprising:
a light-guide plate (4) having first and second main surfaces (5, 6) and being arranged to receive light from at least one light source and to at least partly constrain the light therein by means of total internal reflection, and
at least one local out-coupling device being arranged to selectively extract light from a local area of said second main surface (6) by reducing the index of refraction drop at that area, wherein said local out-coupling device comprises:
a cell adjoining said second main surface and containing first and second immiscible media (11, 12), the first medium (11) being a liquid and the second medium (12) having a lower index of refraction than the first medium, and
an electrode arrangement (19, 21, 22), which is arranged to selectively alter the shape of the interface between the first and second media such that, in a first state, the second medium (12) substantially covers the second main surface (6) in the local area so as to prohibit local optical contact between the first medium (11) and the second main surface (6), while in a second state, the first medium (11) is in optical contact with the second main surface (6) at the local area and enables light out-coupling from the light-guide plate (4) therethrough.

2. A lighting device according to claim 1, wherein, at least at the local area where the second main surface can come into optical contact with the first medium (11), the second main surface (6) is covered with an ultrahydrophobic coating (13), such that said optical contact is not accompanied by an occurrence of a substantial adhesive interaction between the second main surface (6) and the first medium (11).

3. A lighting device according to claim 1, wherein the cell is defined by a transparent support plate (8), the light-guide plate (4), and lateral wall parts (9, 10, 40, 41) interconnecting the support plate and the light-guide plate.

4. A lighting device according to claim 3, wherein the transparent support plate (8) comprises first and second main surfaces, the first main surface facing the cell and the second main surface facing away from the cell, said transparent support plate comprising an out-coupling structure (34).

5. A lighting device according to claim 1, comprising at least one light source (28), which is arranged to feed light through an edge of the light-guide plate (4), the edge interconnecting the first and second main surfaces (5, 6).

6. A lighting device according to claim 1, comprising at least one light source (30), which is arranged to feed light through the first main surface of the light-guide plate (4), the first main surface comprising an in-coupling structure (32, 33).

7. A lighting device according to claim 6, comprising a reflector (31), the reflector and the light-guide plate enclosing the light source (30).

8. A lighting device according to claim 1, comprising a matrix of individually controllable out-coupling devices.

9. A lighting device according to 1, wherein the first medium is colored.

10. A lighting device according to claim 8, wherein said matrix of individually controllable out-coupling devices comprises differently colored first media.

11. A lighting device according to claim 1, wherein the lighting device is arranged as a backlighting unit in a display device such as a liquid crystal display.

12. A lighting device according to claim 1, wherein the lighting device is arranged in a room-lighting arrangement.
